(19) United States
(12) Patent Application Publication
(10) Pub. No.: US 2021/0068436 A1
(43) Pub. Date: Mar. 11, 2021

(54) VANILLA COMPOSITION

(71) Applicant: FIRMENICH SA, Satigny (CH)

(72) Inventors: Maryline BILLAT-ROSSI, Satigny (CH); Patrick SALORD, Satigny (CH); Echo Hong SHEN, Shanghai (CN); Yong Ming YUAN, Shanghai (CN)

(21) Appl. No.: 16/772,662

(22) PCT Filed: Sep. 30, 2019
(86) PCT No.: PCT/EP2019/076477

§ 371 Date: Jun. 12, 2020

(30) Foreign Application Priority Data
Sep. 29, 2018 (CN) PCT/CN2018/108581
Dec. 4, 2018 (EP) 18209966.3
Jul. 4, 2019 (EP) 19184513.0

(51) Int. Cl. A23L 27/20; A23L 27/00; A23L 27/10

(52) U.S. Cl. CPC A23L 27/204; A23L 27/10; A23L 27/88

(57) ABSTRACT

Described herein is a composition for conferring, enhancing, or imparting a vanilla note, the composition including 2-hydroxy-4-methoxybenzaldehyde and vanillin imparted compound selected from the group of 3-methoxy-4-hydroxybenzaldehyde or 4-hydroxy-3-ethoxybenzaldehyde. Also described herein is a perfumed or flavored consumer product including this composition. Moreover, described are an extract including at least 10% of 2-hydroxy-4-methoxybenzaldehyde, and a method to improve, enhance, or modify the vanilla flavour profile of a composition using such an extract.

### FIELD OF THE INVENTION

The present invention relates to a composition for conferring, enhancing or imparting a vanilla note comprising 2-hydroxy-4-methoxybenzaldehyde and vanillin imparted compound selected from the group of 4-hydroxy-3-methoxybenzaldehyde or 3-ethoxy-4-hydroxybenzaldehyde and to a perfumed or flavored consumer product comprising the invention's composition. Moreover, the present invention concerns an extract comprising at least 10% of 2-hydroxy-4-methoxybenzaldehyde and a method to improve, enhance or modify the vanilla flavour profile of a composition using said extract.

### BACKGROUND OF THE INVENTION

Vanilla is a common and popular flavoring material for various applications, such as in perfuming compositions, food, beverages and the pharmaceutical industry. Since the supply of vanilla pods is limited, the cost of vanilla pods and consequently of the vanilla extract is continuously increasing. Investigations have been done to blend or to replace natural vanilla extracts while attempting to retain its unique and desirable flavor and aroma. One of the major components present in vanilla pods or vanilla beans mainly responsible of the vanilla organoleptic properties is a phenolic aldehyde, i.e., 4-hydroxy-3-methoxybenzaldehyde also known as vanillin Said compound has been widely used in consumer product in order to reconstitute the vanilla flavor avoiding the use of very expensive vanilla extract. In the meantime, the demand of natural flavor expands boosting the use of natural vanillin at the expense of synthetic vanillin. However, natural vanillin also suffers from a high price.

So, there is a need to develop a vanilla flavor which could be labeled as natural at a reasonable price.

The present invention addresses these needs by providing a composition comprising 4-hydroxy-3-methoxybenzaldehyde and 2-hydroxy-4-methoxybenzaldehyde in a specific ratio. 2-hydroxy-4-methoxybenzaldehyde has been reported in EP 1806058 to impart a vanilla flavor or in combination of vanilla to enhance the taste of vanilla. However, said prior art is silent toward the effect of a small amount of 2-hydroxy-4-methoxybenzaldehyde in combination of 4-hydroxy-3-methoxybenzaldehyde or 3-ethoxy-4-hydroxybenzaldehyde. The invention composition allows decreasing the total amount of 4-hydroxy-3-methoxybenzaldehyde or 3-ethoxy-4-hydroxybenzaldehyde needed to reconstitute the vanilla flavor which could be natural and affordable.

### SUMMARY OF THE INVENTION

The present invention now provides a composition allowing decreasing the amount of vanillin in the final flavored consumer product of at least twice rendering the use of natural vanillin competitive.

So a first object of the present invention is a flavoring or perfuming composition for conferring, enhancing or imparting a vanilla note comprising 2-hydroxy-4-methoxybenzaldehyde and 4-hydroxy-3-methoxybenzaldehyde characterized in that the weight ratio between 2-hydroxy-4-methoxybenzaldehyde and 4-hydroxy-3-methoxybenzaldehyde is comprised between 1:20 and 1:10000.

A second object of the present invention is a flavoring or perfuming composition for conferring, enhancing or imparting a vanilla note comprising 2-hydroxy-4-methoxybenzaldehyde and 3-ethoxy-4-hydroxybenzaldehyde.

Another object of the present invention is a flavored consumer product comprising a composition as defined above.

Another object of the present invention is a method to confer, enhance, improve or modify the odor or flavor properties of a flavoring or perfuming composition or of a flavored or perfumed article, which method comprises adding to said composition or article an effective amount of composition as defined above.

Another object of the present invention is an extract comprising at least 10% of 2-hydroxy-4-methoxybenzaldehyde.

A further object of the present invention is a method to improve, enhance or modify the vanilla flavour profile of a composition using the extract as defined above.

### DETAILED DESCRIPTION OF THE INVENTION

Unless stated otherwise, percentages (%) or ppm are meant to designate a percentage by weight of a composition.

It has been discovered that 2-hydroxy-4-methoxybenzaldehyde blends particularly well with 4-hydroxy-3-methoxybenzaldehyde enhancing its perception. In particular, a synergistic effect has been obtained with small amount of 2-hydroxy-4-methoxybenzaldehyde which boosts the organoleptic properties of 4-hydroxy-3-methoxybenzaldehyde leading to a decrease of vanillin in the final product. The invention's composition allows using vanillin even natural vanillin while maintaining an acceptable price.

So, the first object of the present invention is a flavoring or perfuming composition for conferring, enhancing or imparting a vanilla note comprising 2-hydroxy-4-methoxybenzaldehyde and 4-hydroxy-3-methoxybenzaldehyde characterized in that the weight ratio between 2-hydroxy-4-methoxybenzaldehyde and 4-hydroxy-3-methoxybenzaldehyde is comprised between 1:20 and 1:10000.

The invention's composition may be provided in an effective amount to confer, enhance or impart a vanilla note.

According to any of the above embodiment, the weight ratio between 2-hydroxy-4-methoxy benzaldehyde and 4-hydroxy-3-methoxybenzaldehyde may be comprised between 1:20 and 1:8000, preferably between 1:50 and 1:6000, preferably between 1:50 and 1:4000, preferably between 1:50 and 1:2000, preferably between 1:50 and 1:1000, preferably between 1:60 and 1:500, preferably between 1:70 and 1:400, preferably between 1:80 and 1:300, even more preferably between 1:90 and 1:300. Additional useful subranges may be from 1:80 to 1:120, from 1:170 to 1:210, from 1:230 to 1:270, or from 1:380 to 1:420. The preferred ratio between 2-hydroxy-4-methoxy benzaldehyde and 4-hydroxy-3-methoxybenzaldehyde is 1:20, 1:35, 1:50, 1:100, 1:190, 1:200, 1:250, 1:400, 1:500 or 1:780, preferably, 1:20, 1:50, 1:100; 1:200, 1:250 or 1:500.

The invention's composition may be in the form of a food matrix, food substance or other edible product.

Preferably, the invention composition is a flavoring composition.

4-hydroxy-3-methoxybenzaldehyde may be obtained by extraction, natural process, synthetic process or combination of natural and synthetic process starting from natural or synthetic sources/starting materials. The extraction of 4-hydroxy-3-methoxybenzaldehyde is mainly done starting from vanilla pods or beans using conventional extraction processes, such as, but not limited to, supercritical fluid extraction in particular with CO₂ as supercritical fluid, soxhlet extraction and ultrasound assisted extraction using different solvents and different operating temperatures. Typically, ethanol, methanol, acetonitrile, acetone, chloroform and hexane have been used in the ranges of 90-100° C. (Jadhav et al., Extraction of vanillin from vanilla pods: A comparison study of conventional soxhlet and ultrasound assisted extraction, Journal of Food Engineering, volume 93, issue 4, August 2009, pages 421-426). By natural process, it is meant plant microbiology process, fermentation, microbiological process or enzymatic process. Examples of suitable natural or synthetic sources/starting materials includes, but are not limited to, ferulic acid; natural ferulic acid such as, but not limited to, the one obtained from rice, beetroots or wheat; eugenol; natural eugenol such as, but not limited to, the one obtained from clove; isoeugenol; natural isoeugenol such as, but not limited to, the one obtained from clove; guaiacol such as, but not limited to, the one obtained from catechol; natural guaiacol such as, but not limited to, the one obtained from conifers; lignin such as, but not limited to, the one obtained from paper pulp or spruce wood; coniferyl alcohol; natural coniferyl alcohol such as, but not limited to, the one obtained from spruce wood; coniferyl aldehyde; natural coniferyl aldehyde; 4-methylguaiacol; natural 4-methylguaiacol; glucose such as, but not limited to, the one obtained from corn sugar; siam benzoin resin; curcumin or natural curcumin such as, but not limited to, the one obtained from curcumin or turmeric. 4-hydroxy-3-methoxybenzaldehyde may be purchased. Non-limiting examples of commercially available 4-hydroxy-3-methoxybenzaldehyde include the one sold under the name or trade name Rhovanil® (trademark from Solvay and commercially available from Solvay), Vanifolia® (trademark from Solvay and commercially available from Solvay), ABTVanforall™ (trademark from Advanced Biotech and commercially available from Advanced Biotech), VanilAFF™ (trademark from Apple Flavors and Fragrances and commercially available from Apple Flavors and Fragrances), Vani-max™ (trademark from Comax Flavors and commercially available from Comax Flavors), Ennallin® (trademark from Ennolys and commercially available from Ennolys), PurVan™ (trademark from Premium Flavor Systems and commercially available from Premium Flavor Systems), Bestvanil™ (trademark from Xiamen Bestally Biotechnology Co., Ltd and commercially available from Xiamen Bestally Biotechnology Co., Ltd), Natural Vanillin ex Ferulic Acid (commercially available from Axxence Aromatic GmbH), Vafecid (commercially available from Kunshan Asia Aroma Corp Ltd), Symvanil (commercially available from Symrise), Vanillin ex turmeric EU natural (commercially available from Advance Biotech), Vanillin natural (commercially available from Advance Biotech) and Vanillin 958 (commercially available from Indesso Vanillin ex-eugenol). 4-hydroxy-3-methoxybenzaldehyde may be use as a pure compound or may be part of a complex mixture. By the term “complex mixture”, it is meant the normal meaning in the art, i.e. a composition comprising several compounds. Suitable complex mixture may be an extract such as vanilla extract.

According to a particular embodiment, 4-hydroxy-3-methoxybenzaldehyde may be obtained by synthetic process; i.e. synthetic 4-hydroxy-3-methoxybenzaldehyde is used.

According to a particular embodiment, 4-hydroxy-3-methoxybenzaldehyde may be obtained by a natural process. More particularly, 4-hydroxy-3-methoxybenzaldehyde may be obtained by fermentation in a presence of sugar.

According to a particular embodiment, 4-hydroxy-3-methoxybenzaldehyde may be obtained starting from natural ferulic acid.

According to a particular embodiment, 4-hydroxy-3-methoxybenzaldehyde may be obtained starting from natural eugenol.

2-hydroxy-4-methoxybenzaldehyde may be obtained by extraction, natural process, synthetic process or combination of natural and synthetic process starting from natural or synthetic sources/starting materials. According to a particular embodiment, 2-hydroxy-4-methoxybenzaldehyde may be obtained by extraction from Biondia hemsleyana, Periploca graeca, Periploca sepium, Periploca angustifolia, Periploca laevigata, Stelmocrypton khasianum, Tylophora indica, Decalepis hamiltonii, Decalepis arayalpathra, Hemidesmus indicus, Mondia whitei, Tarenna attenuata, Periploca genus or other related botanical species known or expected to contain 2-hydroxy-4-methoxybenzaldehyde. Preferably, the botanical source may be Periploca sepium, Periploca angustifolia, Periploca laevigata, Decalepis hamiltonii, Hemidesmus indicus or Mondia whitei. Even more preferably, the botanical source may be Periploca sepium. 2-hydroxy-4-methoxybenzaldehyde may be used as a pure compound or may be part of a complex mixture such as an extract. According to a particular embodiment, 2-hydroxy-4-methoxybenzaldehyde is part of a Periploca sepium extract and/or Decalepis hamiltonii extract.

According to a particular embodiment, 2-hydroxy-4-methoxybenzaldehyde is in the form of a extract from a natural source. Said extract comprises at least 10%, 20%, 30%, 40%, 50%, 60%, 70%, 80%, 90%, 95% or 99% of 2-hydroxy-4-methoxybenzaldehyde. Said extract comprises at most 500 ppm of 3-hydroxy-4-methoxybenzaldehyde. Preferably, said extract may comprise at most 250 ppm, 100 ppm, 80 ppm or 50 ppm of 3-hydroxy-4-methoxybenzaldehyde. The natural source of 2-hydroxy-4-methoxybenzaldehyde is Biondia hemsleyana, Periploca graeca, Periploca sepium, Periploca angustifolia, Periploca laevigata, Stelmocrypton khasianum, Tylophora indica, Decalepis hamiltonii, Decalepis arayalpathra, Hemidesmus indicus, Mondia whitei, Tarenna attenuata, Periploca genus. Preferably, the natural source may be Periploca sepium, Periploca angustifolia, Periploca laevigata, Decalepis hamiltonii, Hemidesmus indicus or Mondia whitei. Even more preferably, the natural source may be Periploca sepium.

The concentration of 2-hydroxy-4-methoxybenzaldehyde is in the range of from 0.001 to 50 ppm ready-to-consume (RTC), preferably in a range from 0.005 to 20 ppm, preferably in a range from 0.005 to 10 ppm, in a range from 0.005 to 1 ppm, even preferably in a range from 0.01 to 0.5 ppm.

The concentration of 4-hydroxy-3-methoxybenzaldehyde is in the range of from 0.5 to 2000 ppm ready-to-consume (RTC), preferably in the range of from 0.5 to 1000 ppm, preferably in the range of from 0.5 to 600 ppm, preferably in the range of from 10 to 500 ppm, even more preferably in the range of from 20 to 400 ppm. When 4-hydroxy-3-methoxybenzaldehyde is part of a vanilla extract, the concentration of vanilla extract is in the range of from 1000 to 30000 ppm ready-to-consume (RTC), preferably in the range of from 1500 to 10000 ppm, preferably in the range of from 1500 to 5000 ppm, even more preferably in the range of from 2000 to 4000 ppm.

According to any one of the above embodiments, the invention's composition may further comprise one or more flavoring or perfuming co-ingredient.

By “flavoring or perfuming co-ingredient” it is meant here a compound, which is used in flavoring or perfuming preparations or compositions to impart a hedonic effect. In other words such an ingredient, to be considered as being a flavoring or perfuming one, must be recognized by a person skilled in the art as being able to impart or modify in a positive or pleasant way the taste or the odor of a composition, and not just as having a taste or an odor.

The nature and type of the flavoring or perfuming co-ingredients present in the composition do not warrant a more detailed description here, the skilled person being able to select them on the basis of its general knowledge and according to intended use or application and the desired organoleptic effect. In general terms, these flavoring or perfuming co-ingredients belong to chemical classes as varied as alcohols, aldehydes, ketones, esters, ethers, acetates, nitriles, terpenoids, nitrogenous or sulphurous heterocyclic compounds and essential oils, and said flavoring or perfuming co-ingredients can be of natural or synthetic origin. Many of these co-ingredients are in any case listed in reference texts such as the book by S. Arctander, Perfume and Flavor Chemicals, 1969, Montclair, N.J., USA, or its more recent versions, or in other works of a similar nature, as well as in the abundant patent literature in the field of flavor and perfumery. It is also understood that said co-ingredients may also be compounds known to release in a controlled manner various types of flavoring or perfuming compounds.

A non-limiting list of suitable flavoring co-ingredient which could be used includes phenol, 2-methoxyphenol, 2-methoxy-4-vinyl-phenol, 4-methyl-phenol, 2-methoxy-4-(2-propen-1-yl)phenol, 2-methoxy-4-(1-propen-1-yl)phenol, 2-methoxy-4-methyl-phenol, 2,6-dimethoxy-phenol, 2-ethoxy-5-(1-propenyl)phenol, 4-ethenylphenol, 2-methyl-phenol, 4-hydroxy-benzenemethanol, (4-methoxyphenyl)methyl formate, 4-methoxybenzaldehyde, 3-ethoxy-4-hydroxybenzaldehyde, benzaldehyde, 3,4-dimethoxy-benzaldehyde, 4-methoxy-benzoic acid, 1,3-benzodioxole-5-carbaldehyde, 4-methoxy-benzenemethanol, 3-hydroxy-2-methyl-4H-pyran-4-one, 4-(4-methoxyphenyl)-2-butanone, 4-methoxybenzyl acetate, 4-hydroxy-2,5-dimethyl-3-furanone, 4-methoxy-benzenemethanol acetate, ethyl 3-phenyl-2-propenoate, methyl 3-phenyl-2-propenoate, ethyl benzoate, 1,4-dimethoxy-benzene, 2-ethyl-3-hydroxy-4H-pyran-4-one, 3-phenyl-2-propenal, phenylacetaldehyde, 5,6-dihydro-6-pentyl-2H-pyran-2-one, decanoic acid, butanoic acid; 2-methylpropanoic acid, dihydro-5-pentyl-2(3H)-furanone, methyl 2-hydroxybenzoate, methyl 2-hydroxybenzoate, 6-methyl-2H-1-benzopyran-2-one, 3,4-dihydro-2H-1-benzopyran-2-one, 1-benzopyran-2-one, hexahydro-3,6-dimethyl-2(3H)-benzofuranone, tetrahydro-6-propyl-2H-pyran-2-one, 6-butyltetrahydro-2H-pyran-2-one, 6-heptyltetrahydro-2H-pyran-2-one, 3-phenyl-2-propen-1-ol, 2-furanmethanol, 3-phenyl-2-propenoic acid, 2-furancarboxaldehyde, 3-hydroxy-2-butanone, 2,3-pentanedione, 2-hydroxybenzaldehyde, 5-pentylfuran-2(5H)-one, methyl 2-hydroxy-4-methoxybenzoate, 5-allyl-1,2,3-trimethoxybenzene, (−)-(1R,4E,9S)-4,11,11-trimethyl-8-methylenebicyclo[7.2.0]undec-4-ene, tetrahydro-6-pentyl-2H-pyran-2-one, 3-methylbutanal, 1-(2-hydroxy-4-methoxyphenyl)ethanone, cocoa extract, vanilla extract, benzoin extract, peru balsam extract, tolu extract, Guaiacwood oil and a combination thereof. Preferably, flavoring co-ingredient may be selected from the group consisting of phenol, 2-methoxyphenol, 2-methoxy-4-vinyl-phenol, 4-methyl-phenol, 2-methoxy-4-(2-propen-1-yl)phenol, 2-methoxy-4-(1-propen-1-yl)phenol, 2-methoxy-4-methyl-phenol, 2,6-dimethoxy-phenol, 2-ethoxy-5-(1-propenyl)phenol, 4-ethenylphenol, 2-methyl-phenol, 4-hydroxy-benzenemethanol, (4-methoxyphenyl)methyl formate, 4-methoxybenzaldehyde, 3-ethoxy-4-hydroxybenzaldehyde, benzaldehyde, 3,4-dimethoxy-benzaldehyde, 4-methoxy-benzoic acid, 1,3-benzodioxole-5-carbaldehyde, 4-methoxy-benzenemethanol, 3-hydroxy-2-methyl-4H-pyran-4-one, 4-(4-methoxyphenyl)-2-butanone, 4-methoxybenzyl acetate, 4-hydroxy-2,5-dimethyl-3-furanone, 4-methoxy-benzenemethanol acetate, 3-phenyl-2-propenyl-ol, 2-furanmethanol, 3-phenyl-2-propenoic acid, 2-furancarboxaldehyde, 3-hydroxy-2-butanone, 2,3-pentanedione, Tetrahydro-6-pentyl-2H-pyran-2-one, 3-methyl-butanal, 1-(2-hydroxy-4-methoxyphenyl)ethanone, cocoa extract, vanilla extract, benzoin extract, peru balsam extract, tolu extract, Guaiacwood oil and a combination thereof. Even more preferably, the flavoring co-ingredient may be selected from the group consisting of phenol, 2-methoxyphenol, 2-methoxy-4-vinyl-phenol, 2-methoxy-4-(2-propen-1-yl)phenol, 2-methoxy-4-(1-propen-1-yl)phenol, 2-methoxy-4-(1-propen-1-yl)phenol, 2-methoxy-4-methyl-phenol, 2-ethoxy-5-(1-propenyl)phenol, 4-ethenylphenol, 4-methoxybenzaldehyde, benzaldehyde, 4-methoxy-benzoic acid; 1,3-benzodioxole-5-carbaldehyde, 3-hydroxy-2-methyl-4H-pyran-4-one, 4-hydroxy-2,5-dimethyl-3-furanone, 1-(2-hydroxy-4-methoxyphenyl)ethanone and a combination thereof.

The concentrations (in ppm RTC) of these compounds are: phenol (0.0001-0.3); 2-methoxyphenol (0.0001-0.5); 2-methoxy-4-vinyl-phenol (0.0001-0.3); 2-methoxy-4-(2-propen-1-yl)phenol; 2-methoxy-4-(1-propen-1-yl)phenol (0.0001-0.1); 2-methoxy-4-methyl-phenol (0.0001-0.5); 2-ethoxy-5-(1-propenyl)phenol (0.0001-5); 4-ethenylphenol (0.0001-0.3); 4-methoxy benzaldehyde (0.0005-5); benzaldehyde (0.0001-5); 4-methoxy-benzoic acid (0.1-200); 1,3-benzodioxole-5-carbaldehyde (0.01-50); 3-hydroxy-2-methyl-4H-pyran-4-one (0.05-200), 4-hydroxy-2,5-dimethyl-3-furanone (0.05-100).

According to any one of the above embodiments, the invention's composition may comprise one or more vanilla enhancer. The term “vanilla enhancer” designates any compounds having a positive impact on the vanilla flavor, in particular compounds allowing to enhance, improve or modify the odor properties of a vanilla flavor composition. Examples of suitable vanilla enhancer include, but are not limited to, 2-methyl-propanal, 1-pentanol, hexanal, 2-methyl-butanoic acid, 3-methyl-butanoic acid, 5-methyl-2-furancarboxaldehyde, heptanal, 1-octen-3-one, 1-octen-3-ol, octanal, 3-hydroxy-4,5-dimethyl-2(5H)-furanone, benzenethanol, 2,6-nonadienal, E-2-nonenal, 2-decanone, 2,4-decadienal, 2-methoxy-4-(methoxymethyl)phenol, (2E)-1-(2,6,6-trimethyl-1,3-cyclohexadien-1-yl)-2-buten-1-one, 2-methyl-butanal, 3-methyl-3-buten-2-one, pentanal, ethyl propanoate, 1,1-diethoxy-ethane, ethyl 2-methylpropanoate, dihydro-2(3H)-furanone, hexanoic acid, 2-heptanone, 3-heptanone, 2-heptenal, ethyl hexanoate, methyl heptanoate, ethyl 4-oxopentanoate, 1-(2-pyrrolyl)-1-ethanone, 1-octanol, 2-decenal, 3-decenal, 4-decenal, 4-(methoxymethyl)phenol, Ethyl nonanoate, methyl 2-aminobenzoate, ethyl 2-aminobenzoate, methyl 2-(methylamino)benzoate, 5-hexyldihydro-2(3H)-furanone, 5-ethyldihydro-2(3H)-furanone, 5-butyldihydro-2(3H)-furanone, 6-hexyltetrahydro-2H-pyran-2-one, 5-heptyldihydro-2(3H)-furanone, 5-octyldihydro-2(3H)-furanone, 5-methyl-2(3H)-furanone, 5-propyldihydro-2(3H)-furanone, 6-methyltetrahydro-2H-pyran-2-one, Decenoic acid, 5-methyldihydro-2(3H)-furanone, 5-butyldihydro-4-methyl-2(3H)-furanone, ethyl 3-phenylpropanoate, 4-hydroxybenzaldehyde, methyl 4-methoxybenzoate, 3-hydroxy-4-methoxybenzaldehyde, 4-hydroxy-3-methoxybenzyl alcohol, 4-(ethoxymethyl)-2-methoxyphenol, 4-hydroxybenzoic acid, Methyl 4-hydroxy-3-methoxybenzoate, Ethyl 4-hydroxy-3-methoxybenzoate, Ethyl 4-hydroxybenzoate, 4-hydroxy-3-methoxybenzoic acid, dodecanoic acid, 4-hydroxy-3,5-dimethoxy-benzaldehyde, (E)-3-(4-hydroxy-3-methoxy-1-phenyl)-2-propenal, tetradecanoic acid, ethyl tetradecanoate, hexadecanoic acid, octadecanoic acid, (Z)-9-octadecennoic acid, ethyl prop-2-enoate, ethyl butanoate, ethyl but-2-enoate, ethyl 2-methylbutanoate, 2-methyl butanoic acid, 1-hexanol, 1-phenyl-ethanone, methyl benzoate, ethyl heptanoate, ethyl octanoate, 1,2-dimethoxy-4-methylbenzene, ethyl dodecanoate, ethyl 4-methoxybenzoate, (3E)-4-(2,6,6-trimethyl-1-cyclohexen-1-yl)-3-buten-2-one, (E)-2-butenal or (E)-1-(4-methoxy-1-phenyl)-1-penten-3-one.

According to any one of the above embodiment, the invention's composition may comprise at least one flavor or perfumery carrier. The term “flavor or perfumery carrier” designates a material which is substantially neutral from a flavor or perfumery point of view, insofar as it does not significantly alter the organoleptic properties of flavoring ingredients or of perfumery ingredients. The carrier may be a liquid or a solid.

Suitable liquid carriers include, for instance, an emulsifying system, i.e. a solvent and a surfactant system, or a solvent commonly used in flavors or perfumery. A detailed description of the nature and type of solvents commonly used in flavor or perfumery cannot be exhaustive. Suitable solvents used in flavor include, for instance, propylene glycol, triacetine, caprylic/capric triglyceride (Neobee®), triethyl citrate, benzylic alcohol, ethanol, vegetable oils such as Linseed oil, sunflower oil or coconut oil, glycerol. One can cite as non-limiting examples of perfumery solvents, solvents such as butylene or propylene glycol, glycerol, dipropyleneglycol and its monoether, 1,2,3-propanetriyl triacetate, dimethyl glutarate, dimethyl adipate 1,3-diacetyloxypropan-2-yl acetate, diethyl phthalate, isopropyl myristate, benzyl benzoate, benzyl alcohol, 2-(2-ethoxyethoxy)-1-ethano, tri-ethyl citrate, ethanol, water/ethanol mixtures, limonene or other terpenes, isoparaffins such as those known under the trademark Isopar® (origin: Exxon Chemical) or glycol ethers and glycol ether esters such as those known under the trademark Dowanol® (origin: Dow Chemical Company), or hydrogenated castors oils such as those known under the trademark Cremophor® RH 40 (origin: BASF) or mixtures thereof.

Suitable solid carriers include, for instance, absorbing gums or polymers, or even encapsulating materials. Examples of such materials may comprise wall-forming and plasticizing materials, such as mono, di- or polysaccharides, natural or modified starches, hydrocolloids, cellulose derivatives, polyvinyl acetates, polyvinylalcohols, xanthan gum, arabic gum, acacia gum or yet the materials cited in reference texts such as H. Scherz, Hydrokolloid: Stabilisatoren, Dickungs- and Geliermittel in Lebensmitteln, Band 2 der Schriftenreihe Lebensmittelchemie, Lebensmittelqualitat, Behr's VerlagGmbH & Co., Hamburg, 1996. Encapsulation is a well-known process to a person skilled in the art, and may be performed, for instance, using techniques such as spray-drying, agglomeration, extrusion, coating, plating, coacervation and the like.

The invention's composition may comprise at least one flavor adjuvant. By “flavor adjuvant”, it is meant here an ingredient capable of imparting additional added benefit such as a color (e.g. caramel), chemical stability, and so on. A detailed description of the nature and type of adjuvant commonly used in flavoring compositions cannot be exhaustive. Nevertheless, such adjuvants are well known to a person skilled in the art who will be able to select them on the basis of its general knowledge and according to intended use or application. One may cite as specific non-limiting examples the following: viscosity agents (e.g. emulsifier, thickeners, gelling and/or rheology modifiers, e.g. pectin or agar gum), stabilizing agents (e.g. antioxidant, heat/light and or buffers agents e.g. citric acid), coloring agents (e.g. natural or synthetic or natural extract imparting color), preservatives (e.g. antibacterial or antimicrobial or antifungal agents, e.g. benzoic acid), vitamins and mixtures thereof.

The invention's composition may comprise at least one perfumery adjuvant. By “perfumery adjuvant” we mean here an ingredient capable of imparting additional added benefit such as a color, a particular light resistance, chemical stability, etc. A detailed description of the nature and type of adjuvant commonly used in perfuming composition cannot be exhaustive, but it has to be mentioned that said ingredients are well known to a person skilled in the art. One may cite as specific non-limiting examples the following: viscosity agents (e.g. surfactants, thickeners, gelling and/or rheology modifiers), stabilizing agents (e.g. preservatives, antioxidant, heat/light and or buffers or chelating agents, such as BHT), coloring agents (e.g. dyes and/or pigments), preservatives (e.g. antibacterial or antimicrobial or antifungal or anti irritant agents), abrasives, skin cooling agents, fixatives, insect repellants, ointments, vitamins and mixtures thereof.

According to any one of the above embodiments, the invention's composition may comprise sweeteners. Non limited-examples of suitable sweeteners includes common saccharide sweeteners, e.g., sucrose, fructose (e.g., D-fructose), glucose (e.g., D-glucose); sweetener compositions comprising natural sugars, such as stevia (all types and grades), corn syrup (including high fructose corn syrup) or other syrups or sweetener concentrates derived from natural fruit and vegetable sources; semisynthetic “sugar alcohol” sweeteners such as erythritol, isomalt, lactitol, mannitol, sorbitol, xylitol, maltodextrin, glycerol, threitol, arabitol, ribitol, and dulcitol; artificial sweeteners such as miraculin, aspartame, superaspartame, saccharin, saccharin-sodium salt, acesulfame-K, cyclamate, sodium cyclamate, and alitame; other sweeteners such as trehalose, melizitose, melibiose, raffinose, palatinose, Iactulose, cyclamic acid, mogroside, tagatose (e.g., D-tagatose), maltose, galactose (e.g., D-galactose), L-rhamnose, D-sorbose, maunose (e.g., D-maunose), lactose, L-arabinose, D-ribose, D-glyceraldehyde, curculin, brazzein, mogroside, Neohesperidin dihydrochalcone (NHDC), neotame and other aspartame derivatives, D-tryptophan, D-Ieucine, D-threonine, glycine, D-asparagine, D-phenylalanine, L-proline, maltitol, hydrogenated glucose syrup (HGS), magap, sucralose, lugduname, sucrononate, sucrooctate, monatin, phyllodulcin, hydrogenated starch hydrolyzate (HSH), stevioside, rebaudioside A, rebaudioside D, rebadioside M, and other sweet Stevia based glycosides, lo han guo, thaumatin, monellin, carrelameand and other guanidine-based sweeteners.

According to any one of the above embodiments, the invention's composition may comprise additional at least one cooling agent. Non limited-examples of suitable cooling agent includes WS-23 (2-Isopropyl-N,2,3-trimethylbutyramide), FEMA 3804; WS-3 (N-Ethyl-p-menthane-3-carboxamide), FEMA 3455; WS-5 [Ethyl 3-(p-menthane-3-carboxamido)acetate], FEMA 4309; WS-12 (1R,2S,5R)—N-(4-Methoxyphenyl)-p-menthanecarboxamide, FEMA 4681; WS-27 (N-Ethyl-2,2-diisopropylbutanamide), FEMA 4557; N-Cyclopropyl-5-methyl-2-isopropylcyclohexanecarboxamide, FEMA 4693, WS-116 (N-(1,1-Dimethyl-2-hydroxyethyl)-2,2-diethylbutanamide), N-(1,1-Dimethyl-2-hydroxyethyl)2,2-diethylbutanamide, FEMA 4603, Menthoxyethanol, FEMA 4154, N-(4-cyanomethylphenyl)-p-menthanecarboxamide, FEMA 4496; N-(2-(Pyridin-2-yl)ethyl)-3-p-menthanecaboxamide, FEMA 4549; N-(2-Hydroxyethyl)-2-isopropyl-2,3-dimethylbutanamide, FEMA 4602 and (also N-(4-(carbamoylmethyl)phenyl)-menthylcarboxamide, FEMA 4684; (1R,2S,5R)—N-(4-Methoxyphenyl)-p-menthanecarboxamide (WS-12), FEMA 4681; (2S,5R)—N-[4-(2-Amino-2-oxoethyl)phenyl]-p-menthanecarboxamide, FEMA 4684; and N-Cyclopropyl-5-methyl-2-isopropylcyclohexanecarbonecarboxamide, FEMA 4693; 2-[(2-p-Menthoxy)ethoxy] ethanol, FEMA 4718; (2,6-Diethyl-5-isopropyl-2-methyltetrahydropyran, FEMA 4680); trans-4-tert-Butylcyclohexanol, FEMA 4724; 2-(p-tolyloxy)-N-(1H-pyrazol-5-yl)-N-((thiophen-2-yl)methyl)acetamide, FEMA 4809; Menthone glycerol ketal, FEMA 3807; menthone glyceryl ketal (FEMA GRAS 3808); (−)-Menthoxypropane-1,2-diol; 3-(1-Menthoxy)-2-methylpropane-1,2-diol, FEMA 3849; Isopulegol; (+)-cis & (−)-trans p-Menthane-3,8-diol, Ratio ˜62:38, FEMA 4053; 2,3-dihydroxy-p-menthane; 3,3,5-trimethylcyclohexanone glycerol ketal; menthyl pyrrolidone carboxylate; (1R,3R,4S)-3-menthyl-3,6-dioxaheptanoate; (1R,2S,5R)-3-menthyl methoxyacetate; (1R,2S,5R)-3-menthyl 3,6,9-trioxadecanoate; (1R,2S,5R)-3-menthyl 3.6,9-trioxadecanoate; (1R,2S,5R)-3-menthyl (2-hydroxyethoxy)acetate; (1R,2S,5R)-menthyl 11-hydroxy-3,6,9-trioxaundecanoate; Cubebol, FEMA 4497; N-(4-cyanomethylphenyl) p-menthanecarboxamide, FEMA 4496; 2-isopropyl-5-methylcyclohexyl 4-(dimethylamino)-4-oxobutanoate, FEMA 4230; N-(4-cyanomethylphenyl) p-menthanecarboxamide, FEMA 4496; N-(2-pyridin-2-ylethyl) p-;menthanecarboxamide, FEMA 4549, Menthyl lactate, FEMA 3748; 6-isopropyl-3,9-dimethyl-1,4-dioxaspiro[4.5]decan-2-one, FEMA 4285; N-benzo[1,3] dioxol-5-yl-3-p-menthanecarboxamide; N-(1-isopropyl-1,2-dimethylpropyl)-1,3-benzodioxole-5-carboxamide; N—(R)-2-oxotetrahydrofuran-3-yl-(1R,2S,5R)-p-menthane-3-carboxamide; mixture of 2,2,5,6,6-pentamethyl-2,3,6,6a-tetrahydropentalen-3a(1H)-ol and 5-(2-hydroxy-2-methylpropyl)-3,4,4-trimethylcyclopent-2-en-1-one; (1R,2S,5R)-2-isopropyl-5-methyl-N-(2-(pyridin-2-yl)ethyl)cyclohexanecarboxamide, FEMA 4549; (2S,5R)-2-isopropyl-5-methyl-N-(2-(pyridin-4-yl)ethyl)cyclohexanecarboxamide; N-(4-cyanomethylphenyl) p-menthanecarboxamide, FEMA 4496; (1S,2S,5R)—N-(4-(cyanomethyl)phenyl)-2-isopropyl-5-methylcyclohexanecarboxamide; 1/7-isopropyl-4/5-methyl-bicyclo[2.2.2]oct-5-ene derivatives; 4-methoxy-N-phenyl-N-[2-(pyridin-2-yl)ethyl]benzamide; 4-methoxy-N-phenyl-N-[2-(pyridin-2-yl)ethyl]benzenesulfonamide; 4-chloro-N-phenyl-N-[2-(pyridin-2-yl)ethyl]benzenesulfonamide; 4-cyano-N-phenyl-N-[2-(pyridin-2-yl)ethyl]benzenesulfonamid; 4-((benzhydrylamino)methyl)-2-methoxyphenol; 4-((bis(4-methoxyphenyl)-methylamino)-methyl)-2-methoxyphenol; 4-((1,2-diphenylethylamino)methyl)-2-methoxyphenol; 4-((benzhydryloxy)methyl)-2-methoxyphenol, 4-((9H-fluoren-9-ylamino)methyl)-2-methoxyphenol; 4-((benzhydrylamino)methyl)-2-ethoxyphenol; 1-(4-methoxyphenyl)-2-(1-methyl-1H-benzo[d]imidazol-2-yl)vinyl4-methoxybenzoate; 2-(1-isopropyl-6-methyl-1H-benzo[d]imidazol-2-yl)-1-(4-methoxyphenyl)vinyl4-methoxybenzoate; (Z)-2-(1-isopropyl-5-methyl-1H-benzo[d]imidazol-2-yl)-1-(4-methoxy-phenyl)vinyl-4-methoxybenzoate; 3-alkyl-p-methan-3-ol derivatives; derivatives of fenchyl, D-bornyl, L-bornyl, exo-norbornyl, 2-methylisobornyl, 2-ethylfenchyl, 2-methylbornyl, cis-pinan-2-yl, verbanyl and isobornyl; menthyl oxamate derivatives; menthyl 3-oxocarboxylic acid esters; N alpha-(Menthanecarbonyl)amino acid amides; p-menthane carboxamide and WS-23 analogs; (−)-(1R,2R,4S)-dihydroumbellulol; p-menthane alkyloxy amides; cyclohexane derivatives; butone derivatives; a mixture of 3-menthoxy-1-propanol and 1-menthoxy-2-propanol; 1-[2-hydroxyphenyl]-4-[2-nitrophenyl-]-1,2,3,6-tetrahydropyrimidine-2-one; 4-methyl-3-(1-pyrrolidinyl)-2[5H]-furanone; and combinations thereof. Preferably, the cooling agent may be selected from the group consisting of menthol, menthol methyl ether, menthone glyceryl acetal (FEMA GRAS 3807), menthone glyceryl ketal (FEMA GRAS 3808), menthyl lactate (FEMA GRAS 3748), menthyl acetate, menthol ethylene glycol carbonate (FEMA GRAS 3805), menthol propylene glycol carbonate (FEMA GRAS 3806), menthyl-N-ethyloxamate, monomethyl succinate (FEMA GRAS 3810), monomenthyl glutamate (FEMA GRAS 4006), menthoxy-1,2-propanediol (FEMA GRAS 3784), menthoxy-2-methyl-1,2-propanediol (FEMA GRAS 3849), (1R,2S,5R)—N-(4-(cyanomethyl)phenyl)menthylcarboxamide (FEMA GRAS 4496), (1R,2S,5R)—N-(2-(pyridin-2-yl)ethyl)menthylcarboxamide (FEMA GRAS 4549), the menthane carboxylic acid esters and amides WS-3, WS-4, WS-5, WS-12, WS-14, WS-30 and mixtures thereof.

According to any one of the above embodiments, the flavored composition may further comprise ingredient imparting a warming, a tingling, a salivating, a cleaning or an alcohol enhancement effect such as capsicum extract, spice extract (e.g. ginger, maniguette, all types of peppers including Sichuan, piperine, capsaicine, jambu extract, spilanthol.

It is understood that a person skilled in the art is perfectly able to design optimal formulations for the desired effect by admixing the above mentioned components of a flavoring or perfuming composition, simply by applying the standard knowledge of the art as well as by trial and error methodologies.

For the sake of clarity, it is also understood that any mixture resulting directly from a chemical synthesis, e.g. a reaction medium without an adequate purification, in which the compounds of the invention would be involved as a starting, intermediate or end-product could not be considered as a flavoring or perfuming composition according to the invention as far as said mixture does not provide the inventive compound in a suitable form for perfumery or for flavor. Thus, unpurified reaction mixtures are generally excluded from the present invention unless otherwise specified.

It has also been found that 2-hydroxy-4-methoxy benzaldehyde can be also combined to 3-ethoxy-4-hydroxybenzaldehyde. So another object of the present invention is a flavoring or perfuming composition for conferring, enhancing or imparting a vanilla note comprising 2-hydroxy-4-methoxybenzaldehyde and 3-ethoxy-4-hydroxybenzaldehyde.

According to any of the above embodiment, the weight ratio between 2-hydroxy-4-methoxy benzaldehyde and 3-ethoxy-4-hydroxybenzaldehyde may be comprised between 1:50 and 1:2000.

The concentration of 3-ethoxy-4-hydroxybenzaldehyde is in the range of from 2 to 300 ppm ready-to-consume (RTC), preferably in the range of from 2 to 100 ppm, preferably in the range of from 2 to 50 ppm and even more preferably in the range of from 4 to 30 ppm.

Another object of the present invention is the use of the invention's composition as flavoring or perfuming composition. In other words, it concerns a method or a process to confer, enhance, improve or modify the odor properties of a flavoring or perfuming composition or of a flavored or perfumed article or of a surface, which method comprises adding to said composition or article an effective amount of the invention's composition, e.g. to impart its typical note.

By “use of the invention's composition” it has to be understood here also the use of any composition containing the invention's composition and which can be advantageously employed in the perfumery or flavor industry.

Furthermore, the invention's composition can be advantageously used in all the fields of flavor to positively impart or modify the taste of a consumer product into which said composition is added. Consequently, the present invention relates to a flavored consumer product comprising the invention's composition as defined above.

For the sake of clarity, by “flavored consumer product” it is meant to designate an edible product or oral composition such as, for example, pharmaceutical compositions, edible gel mixes and compositions, dental compositions, foodstuffs beverages and beverage products. The flavored consumer product may be in a different form. A non-exhaustive list of suitable form of the consumer product may include fried, frozen, marinated, battered, chilled, dehydrated, powder blended, canned, reconstituted, retorted, baked, cooked, fermented, microfiltred, pasteurized, blended or preserved. Therefore, a flavored consumer product according to the invention comprises the invention's composition, as well as optional benefit agents, corresponding to taste and flavor profile of the desired edible product, e.g. a cream dessert.

The nature and type of the constituents of the foodstuffs or beverages do not warrant a more detailed description here, the skilled person being able to select them on the basis of his general knowledge and according to the nature of said product.

Typical examples of said flavored consumer product include:
Baked goods (e.g. breads, dry biscuits, cakes, rice cakes, rice crackers, cookies, crackers, donuts, muffins, pastries, pre-mixes, other baked goods),
Non-alcoholic beverages (e.g. aqueous beverages, enhanced/slightly sweetened water drinks, flavored carbonated and still mineral and table waters, carbonated soft drinks, non-carbonated beverages, carbonated waters, still waters, softs, bottled waters, sports/energy drinks, juice drinks, vegetable juices, vegetable juice preparations, broth drinks),
Alcoholic beverages (e.g. beer and malt beverages, spirituous beverages, wines, liquors),
Instant or ready-to-drink beverages (e.g. instant vegetable drinks, powdered soft drinks, instant coffees and teas, black teas, green teas, oolong teas, herbal infusions, cacaos (e.g. water-based), tea-based drinks, coffee-based drinks, cacao-based drinks, infusions, syrups, frozen fruits, frozen fruit juices, water-based ices, fruit ices, sorbets),
Cereal products (e.g. breakfast cereals, cereal bars, energy bars/nutritional bars, granolas, pre-cooked ready-made rice products, rice flour products, millet and sorghum products, raw or pre-cooked noodles and pasta products),
Dairy based products (e.g. fruit or flavored yoghurts, ice creams, fruit ices, frozen desserts, fresh cheeses, soft cheeses, hard cheeses, milk drinks, wheys, butters, partially or wholly hydrolysed milk protein-containing products, fermented milk products, condensed milks and analogues)
Dairy analogues (imitation dairy products) containing non-dairy ingredients (plant-based proteins, vegetable fats),
Confectionary products (e.g. filings, toppings, chewing gums, hard and soft candies),
Chocolate and compound coatings (e.g. chocolates, spreads),
Products based on fat and oil or emulsions thereof (e.g. mayonnaises, spreads, regular or low fat margarines, butter/margarine blends, flavored oils, shortenings, remoulades, dressings, salad dressings, spice preparations, peanut butters),
Eggs or egg products (dried eggs, egg whites, egg yolks, custards),
Desserts (e.g. gelatins, puddings, dessert creams),
Products made of soya protein or other soya bean fractions (e.g. soya milk and products made therefrom, soya lecithin-containing preparations, fermented products such as tofu or tempeh or products manufactured therefrom, soya sauces),
Vegetable preparations (e.g. ketchups, sauces, processed and reconstituted vegetables, dried vegetables, deep frozen vegetables, pre-cooked vegetables, vegetables pickled in vinegar, vegetable concentrates or pastes, cooked vegetables, potato preparations),
Fruit preparations (e.g. jams, marmalades, canned fruits)
Vegetarian meat analogues or meat replacers, vegetarian burgers
Spices or spice preparations (e.g. mustard preparations, horseradish preparations, pickles), spice mixtures and, in particular seasonings which are used, for example, in the field of snacks.
Snack articles (e.g. baked or fried potato crisps or potato dough products, bread dough products, extrudates based on maize, rice or ground nuts),
Ready dishes (e.g. instant noodles, rice, pastas, pizzas, tortillas, wraps) and soups and broths (e.g. stock, savory cubes, dried soups, instant soups, pre-cooked soups, retorted soups), sauces (instant sauces, dried sauces, ready-made sauces, gravies, sweet sauces, a relish sauces, a sour sauces),
oral care product, such as toothpastes, mouth washes, dental care products (e.g. denture adhesives), dental rinsing, mouth sprays, dental powders, dental gels or dental floss,
pet or animal food.

Preferably, the flavored consumer product may be baked goods, dairy based products, dairy analogues, products based on fat and oil or emulsions thereof, milk products, confectionary products, desserts, chocolate and compound coatings, cereal products, non-alcoholic beverages, alcoholic beverages or instant or ready-to-drink beverages.

Preferably, the flavored consumer product may be covertures and filling, products based on sugars, breads, dry biscuits, cakes, rice cakes, rice crackers, cookies, crackers, donuts, muffins, pastries, pre-mixes, filings, toppings, fruit or flavored yoghurts, ice creams, fruit ices, frozen desserts, spreads, regular or low fat margarines, butter/margarine blends, flavored oils, shortenings, dressings, spice preparations, peanut butters, fresh cheeses, soft cheeses, milk drinks, wheys, butters, partially or wholly hydrolysed milk protein-containing products, fermented milk products, condensed milk and analogues, gelatins, puddings, dessert creams, chocolates, spreads, aqueous beverages, enhanced/slightly sweetened water drinks, flavored carbonated and still mineral and table waters, carbonated soft drinks, non-carbonated beverages, carbonated waters, still waters, softs, bottled waters, sports/energy drinks, juice drinks, vegetable juices, vegetable juice preparations, beer and malt beverages, spirituous beverages, wines, liquors, instant vegetable drinks, powdered soft drinks, instant coffees and teas, black teas, green teas, oolong teas, herbal infusions, cacaos, tea-based drinks, coffee-based drinks, cacao-based drinks, infusions, syrups, chewing gums, hard and soft candies, frozen fruits, frozen fruit juices, water-based ices, fruit ices, sorbets, breakfast cereals, cereal bars, energy bars/nutritional bars, granolas, pre-cooked ready-made rice products, rice flour products, millet and sorghum products, raw or pre-cooked noodles and pasta products.

Some of the above-mentioned flavored consumer products may represent an aggressive medium for the invention's composition, so that it may be necessary to protect the invention's composition from premature decomposition, for example by encapsulation.

The proportions in which the invention's composition can be incorporated into the various of the aforementioned products vary within a wide range of values. These values are dependent on the nature of the consumer product to be flavored and on the desired organoleptic effect as well as the nature of the co-ingredients in a given base when the composition according to the invention are mixed with perfuming or flavoring ingredients, solvents or additives commonly used in the art.

For example, in the case of flavored consumer product, typical concentrations are in the order of 0.001 ppm to 40000 ppm, more preferably, 0.005 ppm to 20000 ppm, even more preferably 0.01 ppm to 10000 ppm, of the invention's composition based on the weight of the consumer product into which they are incorporated.

The invention's composition can also be advantageously used in all the fields of modern perfumery, i.e. fine or functional perfumery, to positively impart or modify the odor of a consumer product into which said composition is added. Consequently, another object of the present invention consists of by a perfumed consumer product comprising, the invention's composition, as defined above.

For the sake of clarity, “perfumed consumer product” is meant to designate a consumer product which delivers at least a pleasant perfuming effect to the surface or space to which it is applied (e.g. skin, hair, textile, air, or home surface). In other words, a perfumed consumer product according to the invention is a perfumed consumer product which comprises a functional formulation, as well as optionally additional benefit agents, corresponding to the desired consumer product, and an olfactive effective amount of the invention's composition. For the sake of clarity, said perfumed consumer product is a non-edible product.

The nature and type of the constituents of the perfumed consumer product do not warrant a more detailed description here, which in any case would not be exhaustive, the skilled person being able to select them on the basis of his general knowledge and according to the nature and the desired effect of said product.

Non-limiting examples of suitable perfumed consumer product include a perfume, such as a fine perfume, a splash or eau de parfum, a cologne or a shave or after-shave lotion; a fabric care product, such as a liquid or solid detergent, a fabric softener, a liquid or solid scent booster, a fabric refresher, an ironing water, a paper, a bleach, a carpet cleaner, a curtain-care product; a body-care product, such as a hair care product (e.g. a shampoo, a coloring preparation or a hair spray, a color-care product, a hair shaping product, a dental care product), a disinfectant, an intimate care product; a cosmetic preparation (e.g. a skin cream or lotion, a vanishing cream or a deodorant or antiperspirant (e.g. a spray or roll on), a hair remover, a tanning or sun or after sun product, a nail product, a skin cleansing, a makeup); or a skin-care product (e.g. a soap, a shower or bath mousse, oil or gel, or a hygiene product or a foot/hand care products); an air care product, such as an air freshener or a “ready to use” powdered air freshener which can be used in the home space (rooms, refrigerators, cupboards, shoes or car) and/or in a public space (halls, hotels, malls, etc. . . . ); or a home care product, such as a mold remover, a furnisher care product, a wipe, a dish detergent or a hard-surface (e.g. a floor, bath, sanitary or a window-cleaning) detergent; a leather care product; a car care product, such as a polish, a wax or a plastic cleaner.

Some of the above-mentioned perfumed consumer products may represent an aggressive medium for the invention's composition, so that it may be necessary to protect the latter from premature decomposition, for example by encapsulation or by chemically binding it to another chemical which is suitable to release the ingredient part of the invention's composition upon a suitable external stimulus, such as an enzyme, light, heat or a change of pH.

Another object of the present invention is an extract comprising at least 10% of 2-hydroxy-4-methoxybenzaldehyde. Preferably, the extract comprises at least 10%, 20%, 30%, 40%, 50%, 60%, 70%, 80%, 90%, 95% or 99% of 2-hydroxy-4-methoxybenzaldehyde. Said extract may comprise 1-(2-hydroxy-4-methoxyphenyl)ethanone. In particular, said extract may comprise from 0.0001% to 0.5% of 1-(2-hydroxy-4-methoxyphenyl)ethanone, preferably from 0.001% to 0.3% of 1-(2-hydroxy-4-methoxyphenyl)ethanone, even more preferably from 0.001% to 0.2% of 1-(2-hydroxy-4-methoxyphenyl)ethanone. Said extract comprises at most 500 ppm of 3-hydroxy-4-methoxybenzaldehyde. Preferably, said extract may comprise at most 250 ppm, 100 ppm, 80 ppm or 50 ppm of 3-hydroxy-4-methoxybenzaldehyde.

According to any embodiments of the present invention, the extract is a plant extract. The plant may be selected from the group consisting of Biondia hemsleyana, Periploca graeca, Periploca sepium, Periploca angustifolia, Periploca laevigata, Stelmocrypton khasianum, Tylophora indica, Decalepis hamiltonii, Decalepis arayalpathra, Hemidesmus indicus, Mondia whitei, Tarenna attenuata, Periploca genus.

Furthermore, the invention's extract can be advantageously used in all the fields of flavor to positively impart or modify the taste of a consumer product into which said extract is added. Consequently, the present invention relates to a flavored consumer product as defined above comprising the invention's extract as defined above.

A further object of the present invention is a method to improve, enhance or modify the vanilla flavour profile of a composition using the extract as defined above.

### EXAMPLES

The invention will now be described in further detail by way of the following examples which illustrate the benefits and advantages of the present invention. 4-hydroxy-3-methoxybenzaldehyde used in examples is available from different sources as mentioned above.

### Example 1

### Preparation of 2-hydroxy-4-methoxybenzaldehyde

The root barks of Periploca sepium were purchased from Yunnan Lorraine Aromatic Products Co. Ltd or the retail market of traditional Chinese medicine. 2 kg root barks of Periploca sepium were steam distillated to obtain a Periploca sepium crude extract. When the Periploca sepium crude extract reached room temperature, it formed an aqueous phase solution and solids in total of around 4.3 kg. The obtained solids were further recrystallized in 14% ethanol. The obtained aqueous phase solution was placed in 4° C. cold room overnight for the formation of crystals. All of the crystals obtained from the Periploca sepium crude extract were collected and subjected to filtration and drying. In total, 4.5 g white crystals were obtained as final products, i.e. natural 2-hydroxy-4-methoxybenzaldehyde.

### Example 2

### Sensory Test

Sensory tests of 2-hydroxy-4-methoxybenzaldehyde prepared as reported in of Example 1 were conducted. Samples A-D were prepared in 6% wt sugar water as shown in table 1. Samples A and B were prepared using 2-hydroxy-4-methoxybenzaldehyde. Sample A contained 0.00001% wt 2-hydroxy-4-methoxybenzaldehyde. Sample B contained 0.00001% wt 2-hydroxy-4-methoxybenzaldehyde with the incorporation of 0.001% wt 4-hydroxy-3-methoxybenzaldehyde (a weight ratio of 1:100). Sample C contained 0.001% wt 4-hydroxy-3-methoxybenzaldehyde. Sample D contained 0.0025% wt 4-hydroxy-3-methoxybenzaldehyde.

TABLE 1
Compositions of samples A-D in 6% sugar water

| | 2-hydroxy-4- | 4-hydroxy-3- |
|---|---|---|
| Sample | methoxybenzaldehyde (% wt) | methoxybenzaldehyde (% wt) |
| A | 0.00001 | 0 |
| B | 0.00001 | 0.00100 |
| C | 0 | 0.00100 |
| D | 0 | 0.00250 |

19 trained panelists tasted samples A-D which were presented as sugar water with vanillin flavor without any other explanation in a blind and randomized order. The panelists were asked to assess the vanillin intensity in a scale of 1-5 (from low to high intensity). The panelists were also asked to rank the strength of vanillin note from 1 to 4 among samples A-D, as 1 being the weakest and 4 being the strongest. The tasting results were analyzed with the Analysis of Variance (ANOVA) test at 99% of confidence. As shown in Tables 2 and 3, the taste results of sample B were surprisingly and significantly different from the other 3 samples. For the perception of vanillin intensity, the order of vanillin intensity (from high to low intensity) is in the sequence of samples B, D, A and C, as shown in table 2. Sample B was given the perception of having the highest vanillin intensity. Sample C was given the perception of having the lowest vanillin intensity. For the ranking of the strength of vanillin note among samples A-D as shown in Table 3, sample C was ranked as having the weakest vanillin note, while sample B was ranked as having the strongest vanillin note, with samples D and A ranked there between.

TABLE 2
Taste test results of vanillin intensity
of samples A-D (on a scale of 1-5)

| | Sample C | Sample A | Sample D | Sample B | Proba. |
|---|---|---|---|---|---|
| Vanillin | 3.21B | 4.14A | 4.73A | 4.91A | 0.0044** |
| Intensity | | | | | |

TABLE 3
Results of taste tests on samples A-D

| Vanillin Note | | | | |
|---|---|---|---|---|
| Strength | | | | |
| (1-weakest, | Number of panelists selecting the sample | | | |
| 4-strongest) | Sample C | Sample A | Sample D | Sample B |
| Rank 1 | 12 | 5 | 0 | 2 |
| Rank 2 | 3 | 6 | 5 | 5 |
| Rank 3 | 4 | 3 | 10 | 2 |
| Rank 4 | 0 | 5 | 4 | 10 |
| Sum of Ranks | 30 | 46 | 56 | 58 |

The sum of ranks is determined my multiplying the selected rank by its rank number (1, 2, 3, or 4) and adding them to the Sum, with the lower numbers depicting higher strengths

This example shown that 4-hydroxy-3-methoxybenzaldehyde may be replaced by the invention's composition; i.e. Sample B, allowing to decrease the amount of 4-hydroxy-3-methoxybenzaldehyde of 2.5 times.

### Example 3

### Sensory Test

Sensory test of 2-hydroxy-4-methoxybenzaldehyde prepared by the method of Example 1 was conducted. Samples E-H were prepared in 6% wt sugar water as shown in Table 4. Samples E and F were prepared using 2-hydroxy-4-methoxybenzaldehyde of the present invention. Sample E contained 0.000013% wt 2-hydroxy-4-methoxybenzaldehyde. Sample F contained 0.000013% wt 2-hydroxy-4-methoxybenzaldehyde with the incorporation of 0.0025% wt 4-hydroxy-3-methoxybenzaldehyde (a weight ratio of 1:192). Sample G contained 0.0025% wt 4-hydroxy-3-methoxybenzaldehyde. Sample H contained 0.005% wt 4-hydroxy-3-methoxybenzaldehyde.

TABLE 4
Compositions of samples E-H in 6% sugar water

| | 2-hydroxy-4- | 4-hydroxy-3- |
|---|---|---|
| | methoxybenzaldehyde | methoxybenzaldehyde |
| Sample | (% wt) | (% wt) |
| E | 0.000013 | 0 |
| F | 0.000013 | 0.0025 |
| G | 0 | 0.0025 |
| H | 0 | 0.005 |

17 trained panelists tasted samples E-H which were presented as sugar water with vanillin flavor without any other explanation in a blind and randomized order. The panelists were asked to assess the vanillin intensity in a scale of 0-10 (from low to high intensity). The tasting results were analyzed with the Analysis of Variance (ANOVA) test. As shown in Table 5, sample F was surprisingly found to provide the highest vanillin intensity compared to the other samples.

TABLE 5
The taste results of vanillin intensity of samples E-H in

| | Sample E | Sample G | Sample H | Sample F | Proba. |
|---|---|---|---|---|---|
| Vanillin | 4.92C | 5.16BC | 6.11AB | 6.64A | 0.0398* |
| Intensity | | | | | |
| (scale of | | | | | |
| 0-10) | | | | | |

Results from the ANOVA (Proba.): Significant difference between the samples at 90% (!)-95% (*)-99% (**) and 99.9% (***). The results from the Duncan Test (A to C) show that there is no significant difference between the samples sharing the same letter. 6.64A is the highest mean score. 4.92C is the lowest mean score

This example shown that 4-hydroxy-3-methoxybenzaldehyde may be replaced by the invention's composition; i.e. Sample F, allowing to decrease the amount of vanillin of 2 times.

### Example 4

### Sensory Tests in a Food Matrix

Sensory tests of 2-hydroxy-4-methoxybenzaldehyde prepared as reported in Example 1 were performed in food matrix, in particular in white yogurt. Tasting solutions I-K were prepared as shown in Table 6. Tasting solutions were added as vanilla flavor boosters to plain white yogurt containing 8% wt sugar. The flavored white yogurts were placed in refrigerator for 30 hours of base maturation prior to testing.

TABLE 6
Compositions of tasting solutions I-K

| | 2-hydroxy-4- | 4-hydroxy-3- | |
|---|---|---|---|
| | methoxy- | methoxy- | Other natural |
| Tasting | benzaldehyde | benzaldehyde | flavouring |
| Solution | (ppm) | (ppm) | substances |
| I | 0 | 100 | 0 |
| J | 0 | 30 | 0.661 |
| K | 0.12 | 30 | 0.661 |

The composition of the flavor containing natural flavouring substances in J and K was identical, the products differed only because of the addition of 2-hydroxy-4-methoxy benzaldehyde in K.

A number of trained panelists were asked to taste the flavored and sugared white yogurts in a blind and randomized order. The flavored white yogurt containing tasting solution K was given the perception of having the most preferred flavor profile which is broader, natural and pleasant, and was also given the perception of having higher flavor strength overall.

This example shown that 4-hydroxy-3-methoxybenzaldehyde may be replaced by the invention's composition; i.e. Sample K, allowing to decrease the amount of vanillin of 3.3 times.

### Example 5

### Sensory Test

Sensory test of 2-hydroxy-4-methoxybenzaldehyde prepared as reported in Example 1 was conducted. Samples L-O were prepared in 6% wt sugar water as shown in Table 7. Samples L, N and O were prepared using 2-hydroxy-4-methoxybenzaldehyde obtained in Example 1. Sample L contained 0.00001% wt 2-hydroxy-4-methoxybenzaldehyde. Sample M contained 0.00001% wt 4-hydroxy-3-methoxybenzaldehyde. Sample N contained 0.00001% wt 2-hydroxy-4-methoxybenzaldehyde and 0.00001% wt 4-hydroxy-3-methoxybenzaldehyde (a weight ratio of 1:1). Sample O contained 0.00001% wt 2-hydroxy-4-methoxybenzaldehyde and 0.005% wt 4-hydroxy-3-methoxybenzaldehyde (a weight ratio of 1:500).

TABLE 7
Compositions of samples E-H in 6% sugar water

| | 2-hydroxy-4- | 4-hydroxy-3- |
|---|---|---|
| | methoxybenzaldehyde | methoxybenzaldehyde |
| Sample | (% wt) | (% wt) |
| L | 0.00001 | 0 |
| M | 0 | 0.00001 |
| N | 0.00001 | 0.00001 |
| O | 0.00001 | 0.005 |

A number of trained panelists were asked to taste sugar water with vanillin flavor without any other explanation in a blind and randomized order. The tasting solution 0, corresponding to the invention's composition, was given the perception of having the most preferred flavor profile which is broader, natural and pleasant, and was also given the perception of having higher flavor strength overall.

### Example 6

### Sensory Test

Sensory test of 2-hydroxy-4-methoxybenzaldehyde prepared as described in Example 1 was conducted. Samples P, Q and R were prepared in 6% wt sugar water as shown in Table 8. Samples P, Q and R were prepared using 2-hydroxy-4-methoxybenzaldehyde obtained in Example 1. Sample P contained 0.00001% wt 2-hydroxy-4-methoxybenzaldehyde coming from Example 1 and 0.001% wt 4-hydroxy-3-methoxybenzaldehyde (a weight ratio of 1:100). Sample Q contained 0.00001% wt 2-hydroxy-4-methoxybenzaldehyde coming from Decalepis hamiltonii extract and 0.001% wt 4-hydroxy-3-methoxybenzaldehyde (a weight ratio of 1:100). Sample R contained 0.000005% wt 2-hydroxy-4-methoxybenzaldehyde coming from Example 1 and 0.000005% wt 2-hydroxy-4-methoxybenzaldehyde coming from Decalepis hamiltonii extract and 0.001% wt 4-hydroxy-3-methoxybenzaldehyde (a weight ratio of 1:1:200)

TABLE 8
Compositions of samples E-H in 6% sugar water

| | | 2-hydroxy-4- | |
|---|---|---|---|
| | | methoxy- | |
| | 2-hydroxy-4- | benzaldehyde | |
| | methoxy- | coming | 4-hydroxy-3- |
| | benzaldehyde | from Decalepis | methoxy- |
| | from Example 1 | hamiltonii extract | benzaldehyde |
| Sample | (% wt) | (% wt) | (% wt) |
| P | 0.00001 | 0 | 0.001 |
| Q | 0 | 0.00001 | 0.001 |
| R | 0.000005 | 0.000005 | 0.001 |

A number of trained panelists were asked to taste the samples in blind condition according to the triangle test protocol were 2 samples are identical and one is different. Tasting P, Q and R were found close.

### Example 7

### Invention's Composition in Consumer Products

a) Muffin

TABLE 9
Composition of muffins

| Ingredients | Grams |
|---|---|
| Shortening 80% fat (CONTISSA) | 217.0 |
| Sunflower oil | 57.0 |
| Whole Eggs | 114.0 |
| Potassium Sorbate | 1.5 |
| Panodan ®¹⁾ A2020 (Datem) | 3.5 |
| Salt | 1.5 |
| Water | 89.0 |
| Crystal Sugar | 238.0 |
| Wheat flour (12% Proteins) | 266.5 |
| Xanthan Gum | 3.0 |
| Baking powder | 9.0 |

¹⁾trademark: Danisco

The shortening was melted in the microwave for 1 minute. Then shortening and sunflower oil were added to a stainless steel or glass bowl and mixed at low speed for 30 seconds. Potassium sorbate, Datem and salt were dissolved in water and blended with the eggs that were previously mixed using a fork. This blend was then combined with the fat and mixed at low speed for 1 to 2 minutes. The sugar was added to the blend and all ingredients were mixed at low speed for 1 minute. Wheat flour, Xanthan gum and baking powder were blended and then sieved to the above described emulsion. All ingredients were then were mixed for another 2 minutes, first at low speed for 1 minute and at increased speed for another minute. The dough was then split into the desired quantities. The invention's composition as reported in Table 17 was added and mixed manually with the base. The muffins were then baked at 180° C. for 15 to 18 minutes depending on their size and cooled down at room temperature.

b) Fat Filling

TABLE 10
Composition of fat filling

| Ingredients | Grams |
|---|---|
| Powdered Sugar/Icing Sugar | 200 |
| (Pure Cane Sugar with Cornstarch) | |
| Shortening (mix of Soybean and Palm Oils) | 100 |

In a stainless steel or glass bowl, half the quantity of icing sugar and the shortening were added and mixed at low speed for 1 minute. Then, the rest of the icing sugar was added and mixed at low speed for 1 minute until a good homogenization of the ingredients was obtained. The blend was then mixed on high speed for 6 minutes to further improve homogenization and until a creamy appearance was achieved. The composition was then split into the desired quantities and the invention's composition as reported in Table 17 was added and mixed manually during 1 to 2 minutes to ensure good homogeneity. Samples were stored at room temperature, and protected from heat and light.

c) Cream Dessert

TABLE 11
Composition of cream dessert

| Ingredients | Amount (%) |
|---|---|
| Full fat pasteurized Milk (3.6% fat) | 86.99 |
| Sugar | 10.00 |
| Modified maize Starch (ROQUETTE) | 2.10 |
| Skimmed milk powder | 0.70 |
| Grindsted Carrageenan Cl 365-DANISCO | 0.08 |
| Orange colour Emulsion | 0.08 |
| (containing 1.65% of beta carotene) | |
| Salt | 0.05 |
| Total | 100.00 |

The cream dessert was prepared by premixing dry ingredients in a beaker. The milk and orange emulsion color were weighted in the Thermomix® pot and dry ingredients were added. The blend was mixed using the Thermomix® without heating for 2-3 minutes at speed 2.5 and then heated up to 90° C. at speed 2.0-2.5. When the temperature was reached, the mixture was heated for 1 more minute. The invention's composition mentioned in Table 17 was weighted in glass beakers and the beakers were covered with thin plastic layer. The hot base was divided in the flavored beakers and mixed well. The obtained flavored mixture was transferred into plastic pots which were cooled down in an ice bath. From time to time, the mixture in the pots was mixed to achieve a creamy consistence. Finally, the pots were stored in the fridge.

d) Yogurt

TABLE 12
Composition of Yogurt application

| Ingredients | Amount (%) |
|---|---|
| Full fat yogurt (3.5% fat) | 92.00 |
| Sugar | 8.00 |
| Total | 100.00 |

The sugar and the yogurt were weighted into a glass beaker and mixed gently until a good homogenization of the two ingredients was obtained. In separate glass beakers, the invention's composition was weighted according to Table 17. Then the sugared yogurt base was added and the blend of ingredients was mixed well. The samples were then stored in the fridge.

e) Cookies

TABLE 13
Composition of cookies

| Ingredients | Grams |
|---|---|
| Sugar | 32.4 |
| Shortening | 20 |
| Eggs, whole | 11 |
| Water | 4 |
| Flour | 32 |
| Salt | 0.3 |
| Baking Soda | 0.3 |

The cookies were prepared by beating sugar and shortening in a large bowl fitted with a paddle until a light and fluffy product was obtained. Then eggs, water, and the invention's composition as reported in Table 17 was added. In a separate bowl, flour, salt, and baking soda were blended and then added to mixture in large bowl. The dough was deposited onto parchment lined baking sheet and baked at 325° F. (convection oven) for 9 minutes. Cookies were cooled down at room temperature and stored in foil Ziploc bags.

f) Soft Serve

Soft serve base, for example from Dingman's Dairy ice cream base with 14% fat, was blended with the invention's composition as reported in Table 17 and then run in the soft serve machine for instance from Carpigiani.

g) Chocolate Milk

TABLE 14
Composition of Chocolate milk

| Ingredient | Amount |
|---|---|
| Reduced Fat Milk (1% FAT) | 96.765% |
| SUGAR | 2.700% |
| Cocoa Powder D-11-S | 0.500% |
| CARRAGEENAN(CL 220 Grinsted) | 0.025% |
| SALT | 0.010% |

The chocolate milk was prepared by combining all ingredients reported in Table 14. Then invention's composition reported in Table 17 was added and the mixtures heated in a UHT at 175° F. for 36 sec. Samples were then cooled down and stored in the fridge.

h) Milk Chocolate

The milk chocolate was prepared using chocolate drops CF-668A R/B Cocoalite from Merckens®. The chocolate drops were melted in the microwave. The invention's composition as reported in Table 15 was added and mixed with the melted chocolate. Samples were deposited and cooled at room temperature before storage.

i) Ready to Drink Coffee

TABLE 15
Composition of Ready to drink Coffee

| Ingredients | Amount | |
|---|---|---|
| 2% Milk | 512.720 | g |
| Water | 440.340 | g |
| Sugar | 71.740 | g |
| Finlays Supreme Spray-Dried Coffee | 12.350 | g |
| CP Kelco Genu Pectin Type YM-100-L | 1.545 | ml |
| (1% w/w Solution) | | |
| Sodium Bicarbonate | 0.457 | g |

The ready-to-drink coffee was prepared by mixing a 1% Pectin solution. Then, water, sugar, coffee, the invention's composition as reported in Table 17, sodium bicarbonate and pectin were mixed until they were fully dissolved. The milk was added slowly prior to mixing the blend well. Samples were filled into retort stable jars and cooked in a pressure cooker for 20 minutes. The jars were removed and tempered in hot water. The product was cooled adding cold water and then refrigerated. Samples were tasted after 1-3 days allowing the product to equilibrate.

j) Carbonated Soft Drink (Cola Type)

TABLE 16
Composition of Carbonated Soft Drink (Cola type)

| Ingredients | Amount (w/v) | |
|---|---|---|
| Caramel Color Low MEI | 6.0 | g |
| HFCS-55 | 879.95 | g |
| Phosphoric Acid | 3.0 | mL |

| | |
|---|---|
| Caffeine | 0.54 |

The carbonated soft drink (CSD), which is a cola type drink was prepared by slowly adding caffeine to 300 ml of warm water. It was mixed until dissolution. Then the 300 ml were added into a 1000 ml graduated cylinder. The HFCS 55, phosphoric acid and caramel color were added and mixed until fully dispersed. Water was added to reach 1000 ml. The invention's composition as reported in Table 17 was added and mixed. The samples were then bottles and carbonated water was added at a rate of 1-5 to syrup. Finally, samples were pasteurized at 165° F. for 15 minutes. The bottles were placed in a warm water bath to temper. After tempering, cool water was added slowly and then the bottles were refrigerated.

TABLE 17
Invention's composition in consumer products

| | Ratio |
|---|---|
| | 2-hydroxy-4-methoxy- |
| | benzaldehyde:4-hydroxy- |
| Consumer Product | 3-methoxybenzaldehyde |
| Chocolate spread | 1:500 |
| Muffin | 1:200 |
| Fat filling | 1:200 |
| Cream dessert | 1:125 |
| Yogurt | 1:200 |
| Cookies | 1:150 |
| Soft Serve | 1:333 |
| Chocolate milk | 1:250 |
| Milk chocolate | 1:90 |
| Ready to drink coffee | 1:100 |
| CSD (Cola type) | 1:250 |

The use of the invention's composition in a consumer product allowed to decrease the amount of 4-hydroxy-3-methoxybenzaldehyde of at least 2.5 times.

It is to be understood that the present invention is not to be limited to the exact description and embodiments as illustrated and described herein. To those of ordinary skill in the art, one or more variations and modifications will be understood to be contemplated from the present disclosure. Accordingly, all expedient modifications readily attainable by one of ordinary skill in the art from the disclosure set forth herein, or by routine experimentation therefrom, are deemed to be within the true spirit and scope of the invention as defined by the appended claims.

1. A flavoring or perfuming composition for conferring, enhancing, or imparting a vanilla note, the composition comprising 2-hydroxy-4-methoxybenzaldehyde and 4-hydroxy-3-methoxybenzaldehyde wherein the weight ratio between 2-hydroxy-4-methoxybenzaldehyde and 4-hydroxy-3-methoxybenzaldehyde is between 1:20 and 1:10000.

2. The composition according to claim 1, wherein the composition is in the form of a food matrix, food substance, or other edible product.

3. The composition according to claim 1, wherein the weight ratio between 2-hydroxy-4-methoxy benzaldehyde and 4-hydroxy-3-methoxybenzaldehyde is between 1:50 and 1:1000.

4. The composition according to claim 3, wherein the weight ratio between 2-hydroxy-4-methoxy benzaldehyde and 4-hydroxy-3-methoxybenzaldehyde is between 1:60 and 1:500.

5. The composition according to claim 1, wherein the concentration of 2-hydroxy-4-methoxybenzaldehyde is in the range of from 0.001 to 50 ppm ready-to-consume.

6. The composition according to claim 1, wherein the composition comprises one or more flavoring compounds.

7. The composition according to claim 6, wherein the flavoring compound is one or more of phenol, 2-methoxyphenol, 2-methoxy-4-vinyl-phenol, 2-methoxy-4-(2-propen-1-yl)phenol, 2-methoxy-4-(1-propen-1-yl)phenol, 2-methoxy-4-(1-propen-1-yl)phenol, 2-methoxy-4-methyl-phenol, 2-ethoxy-5-(1-propenyl)phenol, 4-ethenylphenol, 4-methoxybenzaldehyde, benzaldehyde, 4-methoxy-benzoic acid, 1,3-benzodioxole-5-carb aldehyde, 3-hydroxy-2-methyl-4H-pyran-4-one, 4-hydroxy-2,5-dimethyl-3-furanone, 1-(2-hydroxy-4-methoxyphenyl)ethanone, and a combination thereof.

8. The composition according to claim 1, wherein 2-hydroxy-4-methoxybenzaldehyde is in the form of extract from a natural source.

9. The composition according to claim 8, wherein the extract comprises at least 10% of 2-hydroxy-4-methoxybenzaldehyde.

10. The composition according to claim 8, wherein the extract comprises at most 500 ppm of 3-hydroxy-4-methoxybenzaldehyde.

11. The composition according to claim 8, wherein the natural source of 2-hydroxy-4-methoxybenzaldehyde is Biondia hemsleyana, Periploca graeca, Periploca sepium, Periploca angustifolia, Periploca laevigata, Stelmocrypton khasianum, Tylophora indica, Decalepis hamiltonii, Decalepis arayalpathra, Hemidesmus indicus, Mondia whitei, Tarenna attenuata, Periploca genus.

12. A flavoring or perfuming composition for conferring, enhancing, or imparting a vanilla note comprising 2-hydroxy-4-methoxybenzaldehyde and 3-ethoxy-4-hydroxybenzaldehyde.

13. A flavored consumer product comprising a composition as defined in claim 1.

14. The flavored consumer product according to claim 13, wherein the flavored consumer product is baked goods, dairy based products, dairy analogues, products based on fat and oil or emulsions thereof, milk products, confectionary products, desserts, chocolate and compound coatings, cereal products, non-alcoholic beverages, alcoholic beverages, or instant or ready-to-drink beverages.

15. The flavored consumer product according to claim 14, wherein the flavored consumer product is one or more of covertures and filling, products based on sugars, breads, dry biscuits, cakes, rice cakes, rice crackers, cookies, crackers, donuts, muffins, pastries, pre-mixes, filings, toppings, fruit or flavored yoghurts, ice creams, fruit ices, frozen desserts, spreads, regular or low fat margarines, butter/margarine blends, flavored oils, shortenings, dressings, spice preparations, peanut butters, fresh cheeses, soft cheeses, milk drinks, wheys, butters, partially or wholly hydrolysed milk protein-containing products, fermented milk products, condensed milk and analogues, gelatins, puddings, dessert creams, chocolates, spreads, aqueous beverages, enhanced/slightly sweetened water drinks, flavored carbonated and still mineral and table waters, carbonated soft drinks, non-carbonated beverages, carbonated waters, still waters, softs, bottled waters, sports/energy drinks, juice drinks, vegetable juices, vegetable juice preparations, beer and malt beverages, spirituous beverages, wines, liquors, instant vegetable drinks, powdered soft drinks, instant coffees and teas, black teas, green teas, oolong teas, herbal infusions, cacaos, tea-based drinks, coffee-based drinks, cacao-based drinks, infusions, syrups, chewing gums, hard and soft candies, frozen fruits, frozen fruit juices, water-based ices, fruit ices, sorbets, breakfast cereals, cereal bars, energy bars/nutritional bars, granolas, pre-cooked ready-made rice products, rice flour products, millet and sorghum products, raw or pre-cooked noodles, and pasta products.

16. A method to confer, enhance, improve or modify the odor or flavor properties of a flavoring or perfuming composition or of a flavored or perfumed article, the method comprising adding to said composition or article an effective amount of composition as defined in claim 1.

17. An extract comprising at least 10% of 2-hydroxy-4-methoxybenzaldehyde.

18. The extract according to claim 17, wherein the extract comprises at most 500 ppm of 3-hydroxy-4-methoxybenzaldehyde.

19. The extract according to claim 17, wherein the extract is a plant extract.

20. The natural extract according to claim 19, wherein the plant is selected from the group consisting of Biondia hemsleyana, Periploca graeca, Periploca sepium, Periploca angustifolia, Periploca laevigata, Stelmocrypton khasianum, Tylophora indica, Decalepis hamiltonii, Decalepis arayalpathra, Hemidesmus indicus, Mondia whitei, Tarenna attenuata, and Periploca genus.

21. A method to improve, enhance, or modify the vanilla flavour profile of a composition using the extract as defined in claim 17.
